(19) United States
(12) Patent Application Publication
(10) Pub. No.: US 2018/0074867 A1
(43) Pub. Date: Mar. 15, 2018

(54) PROVIDE COPY OF NOTEBOOK DOCUMENT

(71) Applicant: MICROSOFT TECHNOLOGY LICENSING, LLC, Redmond, WA (US)

(72) Inventors: Ankit Srivastava, Redmond, WA (US); Kiky Tangerine, Vancouver (CA); Hao Cen, Vancouver (CA)

(73) Assignee: MICROSOFT TECHNOLOGY LICENSING, LLC, Redmond, WA (US)

(21) Appl. No.: 15/265,857

(22) Filed: Sep. 15, 2016

(51) Int. Cl. G06F 9/54

(52) U.S. Cl. CPC G06F 9/541; G06F 9/543

(57) ABSTRACT

Variety of approaches to provide a copy of a notebook document are described. A copy application programming interface (API) of a productivity service initiates operations to copy a source notebook document upon receiving a request to copy a designated portion of the source notebook document to a destination. In response to the received request, the copy API retrieves serialized data stored in a source section file associated with the designated portion of the source notebook document. The serialized data is provided such that a new portion of a destination notebook document is constructed at the destination based at least in part on the serialized data.

### BACKGROUND

Information exchange has changed processes associated work and personal environments. Automation and improvements in processes have expanded scope of capabilities offered for personal and business consumption. With the development of faster and smaller electronics, execution of mass processes at cloud systems have become feasible. Indeed, applications provided by data centers, data warehouses, data workstations have become common features in modern personal and work environments. Such systems execute a wide variety of applications ranging from enterprise resource management applications to personal productivity tools. Many such applications manage note taking content and collaboration between users. Collaboration of note taking content consumes significant resources and performance at a promise of improved user productivity.

Improved collaboration techniques are becoming evermore important as communication complexity increases across the computer industry. A variety of techniques are necessary to capture notes, to insert content into notes, and (ultimately) to empower collaboration with note taking content. There are currently significant gaps when re-creating complex note taking content. Lack of relevant duplication methods leads to poor management of note taking content limiting promises of collaboration among users.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a copy of a notebook document. A copy application programming interface (API) of a pro productivity service, according to embodiments, may imitate operations to copy a source notebook document upon receiving a request to copy a designated portion of the source notebook document to a destination. In response to the received request, the copy API may retrieve serialized data stored in a source section file associated with the designated portion of the source notebook document. The serialized data may be provided such that a new portion of a destination notebook document is constructed at the destination based at least in part an the serialized data.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing a copy of a notebook document, according to embodiments;

FIG. 2 is a display diagram illustrating example components of a productivity service that provides a copy of a notebook document, according to embodiments;

FIG. 3 is a display diagram illustrating components of a scheme to provide a copy of a notebook document, according to embodiments;

FIG. 4 is a display diagram illustrating interactions between a client application and a productivity service that provides a copy of a notebook document, according to embodiments;

FIG. 5 is a simplified networked environment, where a system according to embodiments may be implemented;

FIG. 6 is a block diagram of an example computing device, which may be used to provide a copy of a notebook document, according to embodiments; and

FIG. 7 is a logic flow diagram illustrating a process for providing a copy of a notebook document, according to embodiments.

### DETAILED DESCRIPTION

As briefly described above, a productivity service may provide a copy of a notebook document. In an example scenario, the productivity service may use a copy application programming interface (API) to generate a copy of a source notebook document. For example, the copy API may receive a request to copy a designated portion of the source notebook document to a destination. A notebook document may include features to facilitate note taking. For example, a notebook document may allow a variety of input including handwriting, pen, touch based, and/or gesture based, among others. The notebook document may also include functionality to facilitate collaboration between multiple authors. For example, the notebook document may facilitate creation and insertion of content by collaborators. The notebook document may also provide functionality to capture collaborator feedback associated with the content. The notebook document may also capture communications between collaborators and integrate the communications with content. An example of an application that uses notebook documents may include OneNote® by MICROSOFT CORPORATION of Redmond, Wash.

Furthermore, the copy API of productivity service may retrieve serialized data stored in a source section file associated, with the designated portion of the source notebook document. The source notebook document may be stored as serialized data to facilitate transfer of the source notebook document through a network. Serialization is a process to store data structures and/or object states, among other components of the source notebook document into a format that may be stored and/or transmitted. The serialized data of the source notebook document may be stored in section file(s). One of the section files may store the designated portion. The designated portion may include a variety of components of the source notebook document. For example, the designated portion may include a page from the source notebook document.

The copy API may provide the serialized data such that a new portion of a destination notebook document is constructed at the destination based at least in part on the serialized data. The destination may include a destination provider that may be different than a source provider managing the source notebook document. The destination may also include another folder of the source provider.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems. microprocessor-based at programmable consumer electronics, minicomputers, mainframe computers, and comparable computing devices. Embodiments may also be practiced in distributed computing environments where tasks are performed remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of aa volatile computer memory, a non-volatile memory, a hard drive, a flash drive, a floppy disk, or a compact disk, and comparable hardware media.

Throughout this specification, the term “platform” may be a combination of software and hardware components to provide a copy of a notebook document. Examples of platforms include, but are not limited to, a hosted service executed over a plurality of servers, an application executed on a single computing device, and comparable systems. The term “server” generally refers, to a computing device executing one or more software programs typically in a networked environment. More detail on these technologies and example operations is provided below.

A computing, device, as used herein, refers to a device comprising at least a memory and a processor that includes a desktop computer, a laptop computer, a tablet computer, a smart phone, a vehicle mount computer, or a wearable computer. A memory may be a removable or no removable component of a computing device configured to store one or more instructions to be executed by one or more processors. A processor may be a component of at computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content location. A user experience—a visual display, a non-visual display (for impaired users as an example), and or other user experience associated with an application or service through which a user interacts with the application or service. A user action refers to an interaction between a user and a user experience of an application or a user experience provided by a service that includes touch input, gesture input, voice command, eye tracking, gyroscopic input, pen input, mouse input, and/or keyboards input, among others. An application programming interface (API) may be a set of routines, protocols, and tools for an application or service that enable the application or service to interact or communicate with one or more other applications and services managed by separate entities.

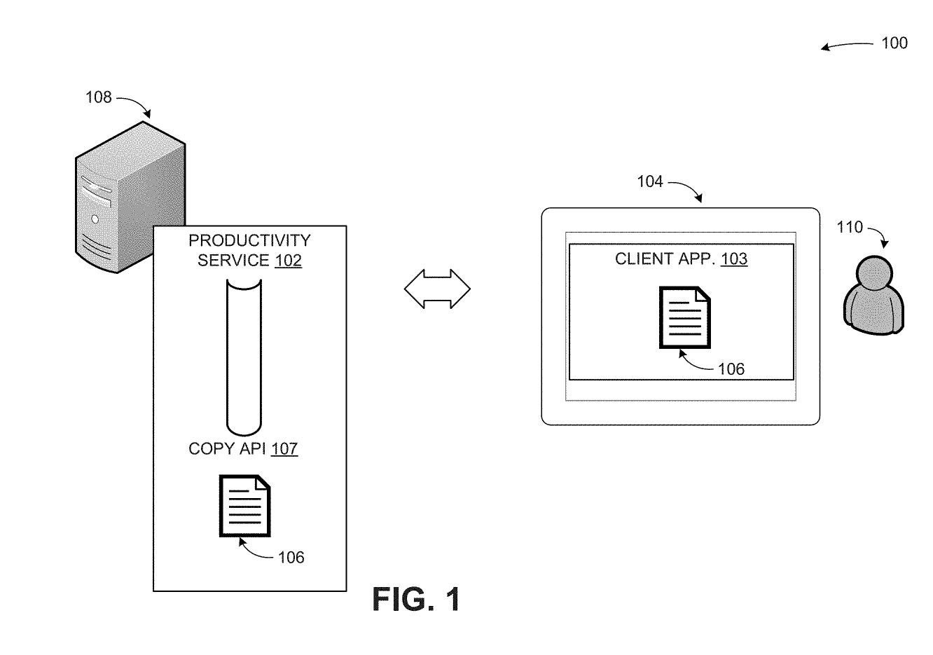

FIG. 1 is a conceptual diagram illustrating examples of providing a copy of a notebook document according to embodiments.

In a diagram 100, a physical server 108 may execute a productivity service 102. The physical server 108 may include a physical server providing service(s) and/or application(s) to client devices. A service may include an application performing operations in relation to a client application and/or a subscriber, among others. The physical server 108 may include and/or is part of a workstation, a data warehouse, a data center, and/or a cloud based distributed computing source, among others.

The physical server 108 may execute the productivity service 102. The productivity service 102 may initiate operations to provide a copy of a source notebook document 106 by engaging a copy API 107. In an example scenario, the copy API may receive a request to copy a designated portion of the source notebook document 106 to a destination. The source notebook document 106 may include features to facilitate note taking and collaboration between author(s). For example, the source notebook document 106 may facilitate creation and insertion of content by collaborators, capture of collaborator feedback associated with the content, and/or integration of communications between collaborators into the content, among others. An author 110 may interact with the source notebook document 106 through a client application 103 executed on a client device 104. The source notebook document 106 may be stored at the physical server 108, the client device 104, and/or a third party provider, among others. However, the productivity service 102 may interact with the source notebook document 106 through the copy API 107 to execute copy operation(s) regardless of the source provider.

The copy API 107 of the productivity service 102 may also retrieve serialized data stored in a section file associated with the designated portion of the source notebook document 106. The source notebook document 106 may be stored as serialized data to facilitate transfer of the source notebook document 106 through a network. The serialized data of the source notebook document 106 may be stored in section file(s). A section file may store the designated portion. The designated portion may include a variety of components of the source notebook document 106 such as a page from the source notebook document.

The copy API 107 of the productivity service may provide the serialized data such that a new portion of a destination notebook document is constructed at the destination based at least in part on the serialized data. The destination may include a destination provider that may be different than a source provider managing the source notebook document. The destination may also include another folder of a source provider such as the productivity service 102.

The copy API 107 may also operate asynchronously. The copy API 107 may engage the source provider to initiate a copy operation to copy the designated portion of the source notebook document 106. The author 110 may poll the copy API 107 for a result of the copy operation. Furthermore, the copy operation may be executed with fetch and push based instructions to the source provider and the destination provider. For example, the productivity service 102 may instruct the copy API 107 to retrieve the designated portion of the source notebook document from the source provider. The copy API 107 may also be instructed to push the designated portion of the source notebook document to a destination notebook document at a destination provider to copy the designated portion to the destination provider.

The physical server 108 may communicate with the client device 104 through a network. The network may provide wired or wireless communications between network nodes such as the client device 104 and/or the physical server 108, among others. Previous example(s) to provide a copy of a notebook document are not provided in a limiting sense. Alternatively, a copy API 107 of the productivity service 102 may copy the source notebook document 106 as a desktop application, a workstation application, and/or a server application, among others. The client application 103 may also include a client interface of the productivity service 102.

The author 110 may interact with the client application 103 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the physical server 108, the productivity service 102, embodiments are not limited to these components or system configurations and can be implemented with other system configuration employing fewer or additional components.

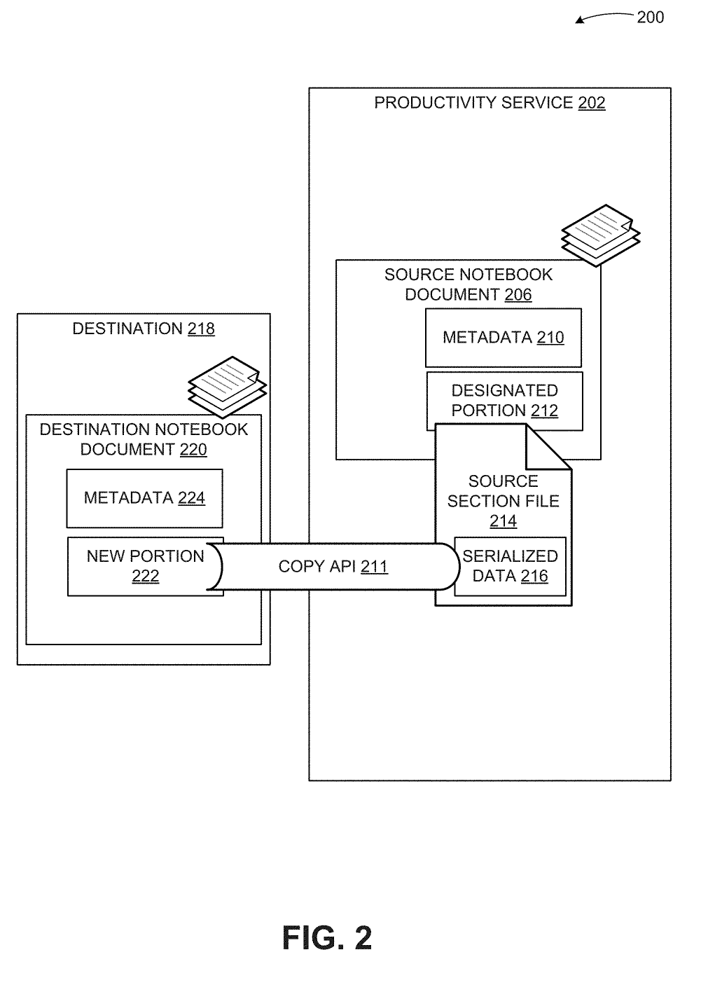

FIG. 2 is a display diagram illustrating example components of a productivity service that provides a copy of a notebook document, according to embodiments.

In diagram 200, a copy API 211 of a productivity service 202 may receive a request to copy a designated portion of a source notebook document 206. The designated portion may include page(s) of the source notebook document and/or a selected content such as an image, among others. The copy API 211 may retrieve serialized data 216 stored in a source section file 214 associated with the designated portion 212 of the source notebook document 206. The productivity service 202 may store the source notebook document 206 in section file(s) formatted as serialized data. The section file(s) may store components (such as a page) of the source notebook document 206 in individual file(s). The serialized data may include data structure, and/or object states, among other components of the source notebook document 206 translated into a format to facilitate storage and/or transmission.

The copy API 211 may provide the serialized data 216 such that a new portion 222 of a destination notebook document 220 is constructed at the destination based at least in part on the serialized data 216. Initially, the copy API 211 may verify whether the destination notebook document 220 may exist in a destination 218. The destination 218 may include a destination provider that manages the destination notebook document 220 or another folder within a source provider that manages the source notebook document 206. If the destination notebook document 220 exists at the destination 208, the copy API 311 may translate the serialized data 216 and insert the translated serialized data into destination notebook document 220 as the new portion 222. A location of insertion may depend on whether a structure of the destination notebook document 230 mirrors the structure of the source notebook document 206. If the structures mirror each other then the copy API 211 may insert the new portion 222 into a location in the destination notebook document 220 that matches a location of the designated portion 212 in the source notebook document 206. If the structures do not mirror each other, then the copy API 211 may insert the new portion 222 into a location within the destination notebook document 220 described by instruction(s) in the request to copy the designated portion 212.

Alternatively, the copy API 211 may fail to detect whether the destination notebook document 220 exists. In such a scenario, the copy API 211 may create the destination notebook document 220 with a copy operation. The content of the source notebook document 206 may be duplicated in the destination notebook document 220 that includes the new portion 222.

Furthermore, upon constructing the new portion 222, the copy API 211 may update a metadata 224 of the destination notebook document 220 with metadata information associated with the designated portion 212. The metadata information associated with the designated portion 212 may be retrieved from a metadata 210 of the source notebook document 206. The metadata information may include attributes associated with the designated portion 212 such as an author, a creation time, a modification time, a description of a modification, and/or a data structure that tracks changes, among others. The metadata information associated with the designated portion 212 may be integrated into the metadata 224 in a location that corresponds to a location of the metadata information within the metadata 210.

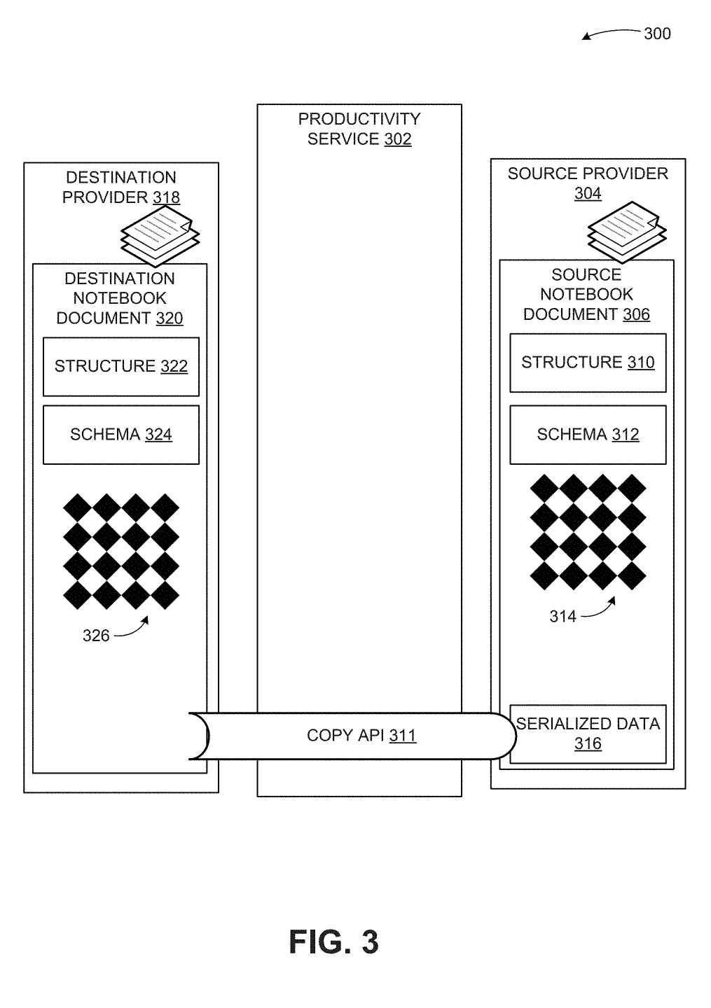

FIG. 3 is a display diagram illustrating components of a scheme to provide a copy of a notebook document, according to embodiments.

In a diagram 300, upon receiving a request, a copy API 311 of a productivity service 302 may copy a source notebook document 306 stored by a source provider 304 to a destination provider 318 as a destination notebook document 320. Alternatively, the destination notebook document 320 may be copied to another folder of the source provider 304 based on instructions in the request.

The copy API 311 may execute a copy operation to copy an entirety of the source notebook document 306 or a portion of the source notebook document 306 based on instruction(s) in the request. For example, the copy API 311 may acquire a structure 310 of a designated portion (or an entirety) of the source notebook document 306. The structure 310 may describe how components the designated portion (or an entirety) of the source notebook document 306 are related and formatted within the source notebook document 306. The structure 310 of the designated portion (or the entirety) of the source notebook document 306 may be recreated as a structure 322 in a new portion (or entirety) of a destination notebook document 320. For example, table(s), section(s), and/or page(s), among other structure elements may be created in the new portion (or the entirety) of the destination notebook document 320. Next, serialized data 316 may be inserted and integrated into the structure 322 to construct the new portion (or the entirety) of the destination notebook document 320.

Alternatively, the copy API 311 may obtain a schema 312 of the designated portion (or the entirety) of the source notebook document 306. The schema 312 may include an outline of components of the designated portion (or the entirety) of the source notebook document 306. An example of the schema 312 may include an extensible markup language (XML) schema that lists the components of the designated portion (or the entirety) of the source notebook document 306 and describes how the components are organized.

The copy API 311 may apply the schema 312 of the designated portion (or the entirety) of the source notebook document 306 as a schema 324 into the destination notebook document 320. An outline of the components of a new portion (or the entirety) of the destination notebook document 320 may be formed. The serialized data 316 may be incorporated into the schema 324 to construct of the new portion (or the entirety) of the destination notebook document 320.

Similarly, the copy API 311 may copy a structure of tiles 314 used to arrange a content of the source notebook document 306 as a structure of tiles 326 into the destination notebook document 320. Tiles enforce consistent structure to components of content where only attributes such as font, color, size, shape, and/or interface, among other configuration(s) vary. The content of the source notebook document 306 may be recreated within the destination notebook document 320 using the structure of the tiles 326.

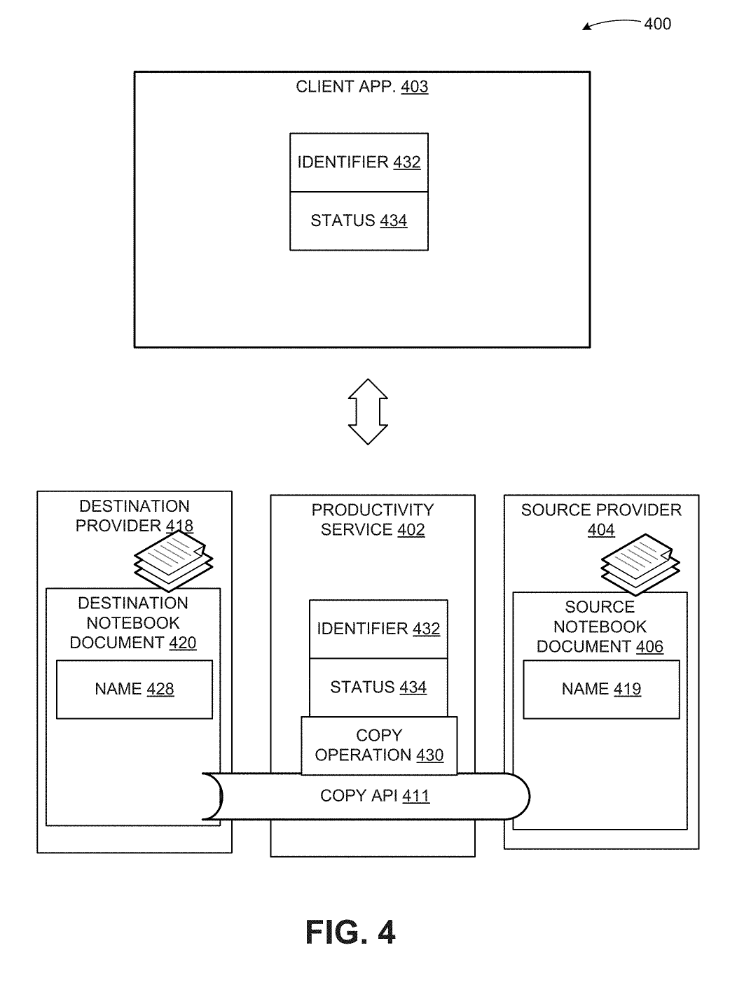

FIG. 4 is a display diagram illustrating interactions between a client application and a productivity service that provides a copy of a notebook document, according to embodiments.

In a diagram 400, a copy API 411 of a productivity service 402 may execute a copy operation 430 in response to a request to copy a source notebook document 406 (stored by a source provider 404) to a destination notebook document 420 (to be stored by a destination provider 418). The copy operation 430 may be customized based on instructions received with the request to copy. For example, the request may include instructions to rename a name 419 of the source notebook document 406 into a name 428 of the destination notebook document 420. If the request does not include any rename instructions, then the name 419 of the source notebook document 406 may be duplicated as the name 428 for the destination notebook document 420.

Furthermore, the copy API 411 may assign an identifier 432 to the copy operation 430. The identifier 432 may be provided to a client application 403 to inform a requester (an author who initiated the copy operation 430) of a start of the copy operation. In addition, the copy API 411 may reply to a received status inquiry from the client application 403. The status inquiry may identify the identifier 432 to direct the copy API 411 to report a status 434 of the copy operation 430. In response, the copy API 411 may query the status 424 of the copy operation 430 which may include a completion rate of the copy operation as well as a condition of the copy operation 430 such as failure or success. The status 424 of the copy operation 430 may be provided to the client application 403 for a presentation to the requester of the copy operation 430.

In addition, the copy API 411 may read the source notebook document 406 asynchronously upon detecting an availability of a resource that manages the source notebook document 406 (at the source provider 404). Similarly, the copy API 411 may write the destination notebook document 420 asynchronously upon detecting an availability of a resource that manages the destination notebook document 420 (at the destination provider 418). Moreover, a metadata of the destination notebook document 420 may also be updated with copy information that describes attributes of the copy operation 430 such as timing, source information, destination information, status 434 of the copy operation 430, and/or an identification of a requester of the copy operation 430, among others.

As discussed above, the copy API 107 of the productivity service 102 may be employed to perform operations to automate providing of a copy of a notebook document. An increased user efficiency with the client interfaces of the productivity service 102 may occur as a result of duplicating a portion or an entirety of a source notebook document in a destination notebook document. Additionally, asynchronous read and write operations to generate the destination notebook document, by the copy API 107 of the productivity service 102, may reduce processor load, increase processing speed, conserve memory, and reduce network bandwidth usage.

Embodiments, as described herein, address a need that arises from a lack of efficiency to provide a copy of the notebook document. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing a copy of a notebook document may be implemented in configurations employing fewer or additional components in applications and user interfaces. Furthermore, the example schema and components shown in FIG. 1 through 4 and their subcomponents may be implemented in a similar manner with other values using the principles described herein.

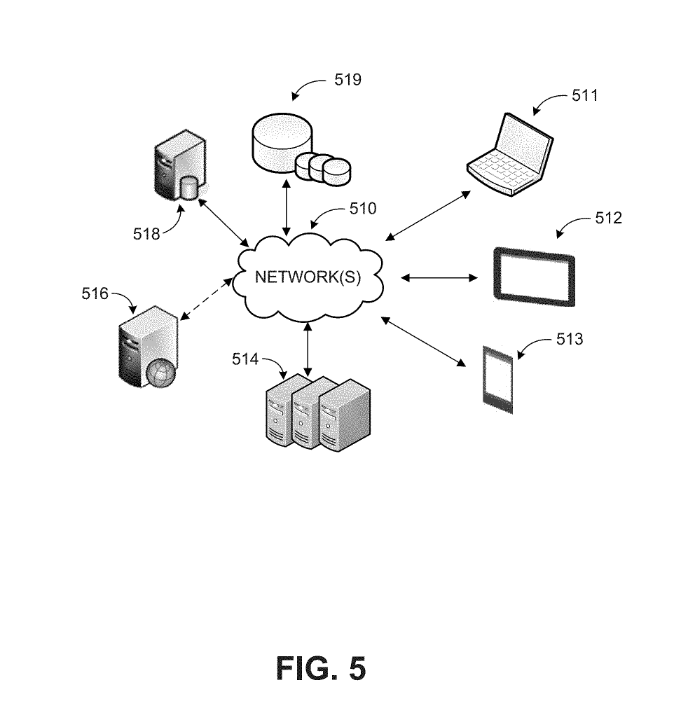

FIG. 5 is an example networked environment, where embodiments may be implemented. A productivity service configured to provide a copy of a notebook document may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A copy API of a productivity service may receive a request to copy a designated portion of a source notebook document to a destination. The copy API may retrieve serialized data in a source section file associated with the designated portion. The serialized data may be provided such that a new portion of a destination notebook document is constructed at the destination based at least in part on the serialized data. The productivity service may store data associated with the meeting in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a copy of a notebook document. Furthermore, the networked environments discussed in FIG. 5 are for illustration purposes only. Embodiments are not limited to the example applications, modules, or processes.

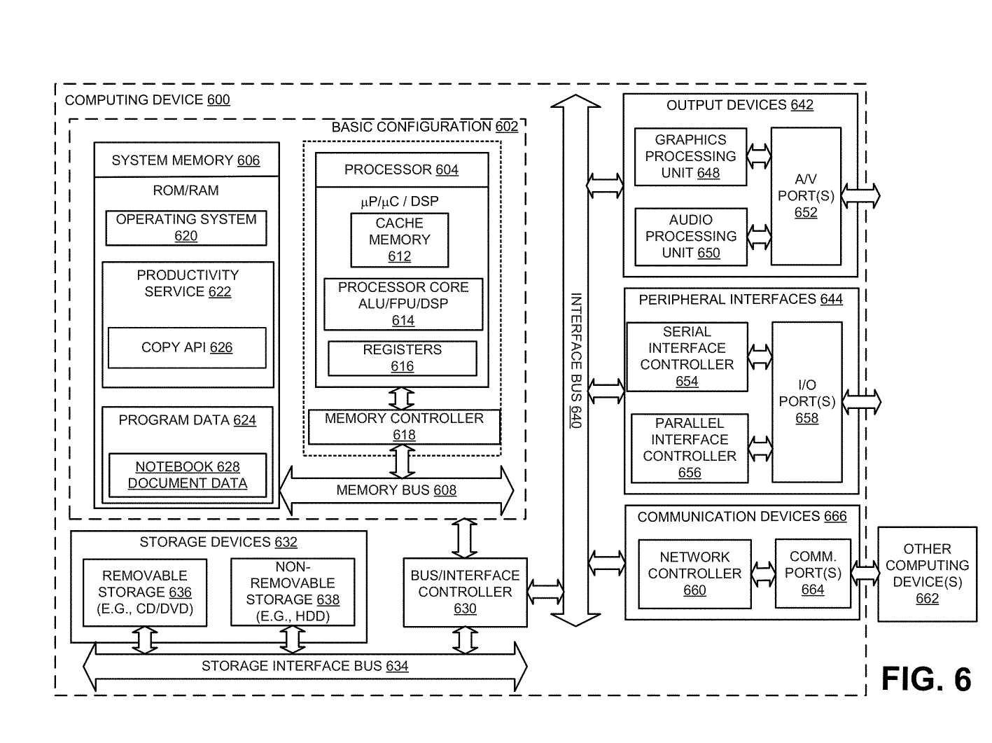

FIG. 6 is a block diagram of an example computing device, which may be used to provide a copy of aa notebook document, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity service 622, and a program data 624. The productivity service 622 may include a component such as a copy API 626. The copy API 626 may execute the processes associated with the productivity service 622. The copy API 626 may receive a request to copy a designated portion of a source notebook document to a destination. The copy API 626 may retrieve serialized data in a source section file associated with the designated portion. The serialized data may be provided such that a new portion of a destination notebook document is constructed at the destination based at least in part on the serialized data.

Input to and output out of the productivity service 622 may be transmitted through a communication module associated with the computing device 600. An example of the communication module may include a communication device 666 that may be communicatively coupled to the computing device 600. The communication module may provide wired and/or wireless communication. The program data 624 may also include, among other data, notebook document data 628, or the like, as described herein. The notebook document data 628 may include serialized data, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide a copy of a notebook document. These methods can be implemented in any number of ways, including the structures described herein. One such way may be by machine operations, of devices of the type described in the present disclosure. Another optional way may be for one or more of the individual operations of the methods to he performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

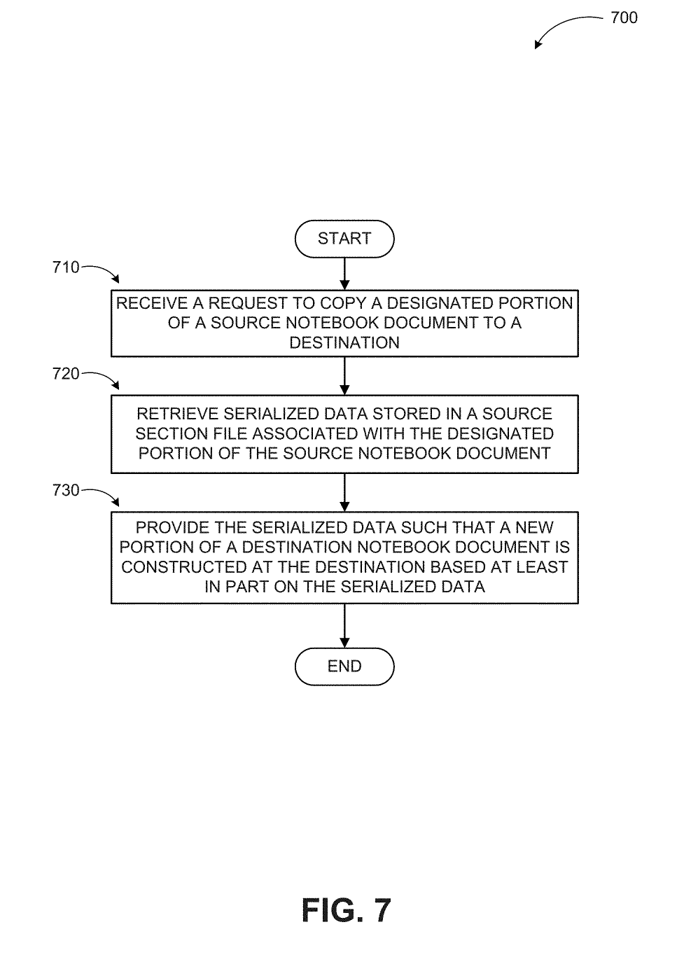

FIG. 7 is a logic flow diagram illustrating a process for providing a copy of a notebook document, according to embodiments. Process 700 may be implemented on a computing device, such as the computing device 600 or another system.

Process 700 begins with operation 710, where a copy API of the productivity service may receive a request to copy a designated portion of a source notebook document to a destination. The destination may include another folder of a source provider or a destination provider different than the source provider. At operation 720, serialized data may retrieved from a source section file associated with the designated portion of the source notebook document. The source notebook document may be stored in section file(s) with a serialized formatting to facilitate storage and/or transmission.

At operation 730, the copy API of the productivity service may provide the serialized data such that a new portion of a destination notebook document is constructed at the destination based at least in part on the serialized data. The new portion may be constructed at a location in the destination notebook document that matches a location of the designated portion in the some notebook document.

The operations included in process 700 is for illustration purposes. Providing a copy of a notebook document may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a physical server to provide a copy of a notebook document is described. The physical server includes a communication module configured to facilitate exchange of notebook documents and other data with computing devices, a memory configured to store instructions associated with a productivity service, and a processor coupled to the memory and the communication module. The processor executes the productivity service in conjunction with the instructions stored in the memory. The productivity service includes a copy application programming interlace (API). The copy APT is configured to receive a request, through the communication module, to copy a designated portion of a source notebook document to a destination, retrieve serialized data stored in a source section file associated with the designated portion of the source notebook document, and provide the serialized data such that a new portion of a destination notebook document is constructed at the destination based at least in part on the serialized data.

In other examples, the copy API is further configured to obtain a metadata associated with the designated portion of the source notebook document and integrate the metadata associated with the designated portion into a metadata of the destination notebook document. The copy API is further configured to in response to a failure to detect the destination notebook document at the destination, create the destination notebook document at the destination. The copy API is further configured to acquire a structure of the designated portion of the source notebook document, recreate the structure of the designated portion of the source notebook document in the new portion of the destination notebook document, and insert the serialized data into the new portion of the destination notebook document. The copy API is further configured to obtain a schema of the designated portion of the source notebook document, apply the schema of the designated portion of the source notebook document into the new portion of the destination notebook document, and incorporate the serialized data into the new portion of the destination notebook document.

In further examples, the destination includes a destination provider that is different than a source provider that stores the source notebook document. The destination includes a destination folder of a source provider that stores the source notebook document in a source folder. The copy API further configured to insert the new portion into a location in the destination notebook document that matches a location of the designated portion in the source notebook document. The copy API is further configured to identify an insertion location within the request and insert the new portion into the insertion location in the destination notebook document.

In other examples, the copy API is further configured to generate an identifier associated with a copy operation to construct the new portion of the destination notebook document and provide the identifier to a requester who transmitted the request to copy the designated portion of the source notebook document. The copy API is further configured to receive a status inquiry that includes the identifier from the requester, query a status of the copy operation to construct the new portion of the destination notebook document, where the status of the copy operation includes a completion rate of the copy operation, and provide the status of the copy operation to the requester.

In some examples, method executed on a computing device to provide a copy of a notebook document is described. The method includes receiving a request to copy a source notebook document to a destination provider, retrieving serialized data of the source notebook document, and providing the serialized data such that a destination notebook document is constructed at the destination provider based at least in part on the serialized data.

In other examples, the method further includes updating metadata of the source notebook document with copy information, where the copy information describes a copy operation to construct the destination notebook document. The method further includes in response to receiving a rename instruction in the request, renaming the destination notebook document based on the rename instruction and in response to a failure to receive a rename instruction in the request, naming the destination notebook document using a name of the source notebook document.

In further examples, retrieving the serialized data of the source notebook document reading the source notebook document asynchronously upon detecting an availability of a resource managing the source notebook document at a source provider. Constructing the destination notebook document includes writing the destination notebook document asynchronously upon detecting an availability of a resource managing the destination notebook document at the destination provider. The method further includes detecting tiles used to arrange a content of the source notebook document, copying a structure of the tiles, and recreating the content of the source notebook document within the destination notebook document using the structure of the tiles.

In some examples, computer-readable memory device with instructions stored thereon to provide a copy of a notebook document is described. The instructions include actions that are similar to actions of the method. The instructions further include acquiring a structure of the designated portion of the source notebook document, recreating the structure of the designated portion of the source document within an existing portion of the destination notebook document, and inserting the serialized data into the recreated structure within the existing portion of the destination notebook document.

In some examples, a means for providing a copy of a notebook document is described. The means for providing a copy of a notebook document includes a means for receiving a request to copy a designated portion of a source notebook document to a destination, a means for retrieving serialized data stored in a source section file associated with the designated portion of the source notebook document, and a means for providing the serialized data such that a new portion of a destination notebook document is constructed at the destination based at least in part on the serialized data.

The above specification, examples and data provide a complete description of the manufacture and use of the composition of the embodiments. Although the subject matter has been described language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A physical server to provide copy of a notebook document, the physical server comprising:
a communication module configured to facilitate exchange of notebook documents and other data with computing devices;
a memory configured to store instructions associated with a productivity service;
a processor coupled to the memory and the communication module, the processor executing the productivity service in conjunction with the instructions stored in the memory, wherein the productivity service includes:
a copy application programming interface (API) configured to:
receive a request, through the communication module, to copy a designated portion of a source notebook document to a destination;
retrieve serialized data stored in a source section file associated with the designated portion of the source notebook document; and
provide the serialized data such that a new portion of a destination notebook document is constructed at the destination based at least in part on the serialized data.

2. The physical server of claim 1, wherein the copy API is further configured to:
obtain a metadata associated with the designated portion of the source notebook document; and
integrate the metadata associated with the designated portion into a metadata of the destination notebook document.

3. The physical server of claim 1, wherein the copy API is further configured to:
in response to a failure to detect the destination notebook document at the destination, create the destination notebook document at the destination.

4. The physical server of claim 1, wherein the copy API is further configured to:
acquire a structure of the designated portion of the source notebook document;
recreate the structure of the designated portion of the source notebook document in the new portion of the destination notebook document; and
insert the serialized data into the new portion of the destination notebook document.

5. The physical server of claim 1, wherein the copy API is further configured to
obtain a schema of the designated portion of the source notebook document;
apply the schema of the designated portion of the source notebook document into the new portion of the destination notebook document; and
incorporate the serialized data into the new portion of the destination notebook document.

6. The physical server of claim 1, therein the destination includes a destination provider that is different than a source provider that stores the source notebook document.

7. The physical server of claim 1, wherein the destination includes a destination folder of a source provider that stores the source notebook document in a source folder.

8. The physical server of claim 1, herein the copy API is further configured to:
insert the new portion into a location in the destination notebook document that matches a location of the designated portion in the source notebook document.

9. The physical server of claim 1, wherein the copy API is further configured to:
identify an insertion location within the request; and
insert the new portion into the insertion location destination notebook document.

10. The physical server of claim 1, wherein the copy API is further configured to:
generate an identifier associated with a copy operation to construct the new portion of the destination notebook document; and
provide the identifier to a requester who transmitted the request to copy the designated portion of the source notebook document.

11. The physical server of claim 10, wherein the copy API is further configured to:
receive a status inquiry that includes the identifier from the requester;
query a status of the copy operation to construct the new portion of the destination notebook document, wherein the status of the copy operation includes a completion rate of the copy operation; and
provide the status of the copy operation to the requester.

12. A method executed on a computing device to provide a copy of a notebook document, the method comprising:
receiving a request to copy a source notebook document to a destination provider;
retrieving serialized data of the source notebook document; and
providing the serialized data such that a destination notebook document is constructed at the destination provider based at least in part on the serialized data.

13. The method of claim 12, further comprising:
updating metadata of the source notebook document with copy information, wherein the copy information describes a copy operation to construct the destination notebook document.

14. The method of claim 12, further comprising:
in response to receiving a rename instruction in the request, renaming the destination notebook document based on the rename instruction; and
in response to a failure to receive a rename instruction in the request, naming the destination notebook document using a name of the source notebook document.

15. The method of claim 12, wherein retrieving the serialized data of the source notebook document comprises:
reading the source notebook document asynchronously upon detecting an availability of a resource managing the source notebook document at a source provider.

16. The method of claim 12, wherein constructing the destination notebook document comprises:
writing the destination notebook document asynchronously upon detecting an availability of a resource managing the destination notebook document at the destination provider.

17. The method of claim 12, further comprising:
detecting tiles used to arrange a content of the source notebook document;
copying a structure of the tiles; and
recreating the content of the source notebook document within the destination notebook document using the structure of the tiles.

18. A computer-readable memory device with instructions stored thereon to provide a copy of a notebook document, the instructions comprising:
receiving a request to copy a source notebook document to a destination provider;
retrieving serialized data of the source notebook document asynchronously upon an availability of a resource managing the source notebook document at a source provider; and
providing the serialized data such that a destination notebook document is constructed at the destination provider based at least in part on the serialized data asynchronously upon another availability of another resource managing the destination notebook document at the destination provider.

19. The computer-readable memory device of claim 18, wherein the instructions further comprise:
acquiring a structure of the designated portion of the source notebook document;
recreating the structure of the designated portion of the source notebook document within an existing portion of the destination notebook document; and
inserting the serialized data into the recreated structure within the existing portion of the destination notebook document.

20. The computer-readable memory device of claim 18, wherein the instructions further comprise:
receiving an attribute change instruction within the request, wherein the attribute change instruction describes a change to an attribute of the destination notebook document;
changing the attribute of the destination notebook document based on the attribute change instruction; and
updating a metadata of the destination notebook document to reflect the change to the attribute of the destination notebook document.
